(19) United States
(12) Patent Application Publication
(10) Pub. No.: US 2016/0107567 A1
(43) Pub. Date: Apr. 21, 2016

(54) INSTRUMENT CLUSTER INCLUDING A PCB MOUNTED LIGHT CONDUCTOR

(71) Applicant: Continental Automotive Systems, Inc., Auburn Hills, MI (US)

(72) Inventors: Humberto Merchand Alvarado, Guadalajara (MX); Monica Abigail Aceves Mendoza, Zapopan (MX); Maria Nohemi Bravo Solis, Tlajomulco de Zuniga (MX)

(21) Appl. No.: 14/515,453

(22) Filed: Oct. 15, 2014

(51) Int. Cl. B60Q 3/04; F21V 8/00; B60Q 3/00

(52) U.S. Cl. CPC B60Q 3/042; B60Q 3/004; G02B 6/0055; B60Q 2500/00

(57) ABSTRACT

An instrument cluster is provided that includes a light conductor or light guide mounted directly to a printed circuit board having a light source. Such a light conductor can be attached to the printed circuit board near the light source using an adhesive, so as to eliminate the need for a separate frame or light housing to support the light conductor relative to the printed circuit board.

### FIELD OF THE INVENTION

The instant invention relates to an instrument cluster, and more particularly, to an instrument cluster having a printed circuit board (PCB) having a light source and a light conductor mounted directly on the PCB.

### DESCRIPTION OF THE RELATED ART

Instrument clusters having printed circuit boards (PCBs) are used in the automobile industry, among others. For example, European Patent Application Publication EP 2235482, incorporated herein by reference, discloses an instrument cluster having a printed circuit board which holds a pointer drive source and an illumination source for a pointer. Additionally, light guides for an instrument cluster are known. See, for example of U.S. Pat. No. 7,592,972 to Eckardt et al. (“the '972 patent”), incorporated herein by reference. Referring now to FIGS. 1 and 2, the '972 patent discloses an instrument display 10 wherein a light guide cluster 14 is mounted to a light housing 12, which is, in turn, mounted to a printed circuit board (PCB) 18 having light emitting diodes 16. See, for example, col. 4 of the '972 patent, lines 43-51. Additionally, as disclosed in col. 3 of the '972 patent, lines 18-20, the light housing [12 of the instant application] provides the background for the light guides [14 of the instant application]. In other words, in the '972 patent, the light guide is separated from the PCB by the light housing. This requires the use of an extra part (i.e., the light housing) between the light guides and the PCB.

Additionally, European Patent Application Publication No. EP 2 587 121 A1 to Kerpe (the '121 reference) discloses LED-based lighting with a reflector mounted on a PCB. In the '121 reference, a plurality of LEDs are mounted to a PCB. Furthermore, a surface mount reflector of a metal sheet with punched out reflector surfaces is located on the PCB. According to the '121 reference, the surface mount reflector and the PCB are held together within a frame.

What is needed is an improved design for lighting an instrument cluster using a light conductor directly attached to a PCB, in order to eliminate the need for a frame structure or light housing.

### SUMMARY OF THE INVENTION

It is accordingly an object of this invention to provide an instrument cluster system that overcomes the disadvantages of the prior art. In one particular embodiment of the invention, an instrument cluster is provided wherein a light conductor is provided that is directly attached to the printed circuit board (PCB) near or adjacent to a light source on the PCB. In another embodiment of the invention, the light conductor provided is a light weight, non-rigid light guide. In a further particular embodiment, a light guide is directly mounted to the PCB using adhesive.

Although the invention is illustrated and described herein as embodied in an instrument cluster including a PCB mounted light conductor, it is nevertheless not intended to be limited to the details shown, since various modifications and structural changes may be made therein without departing from the spirit of the invention and within the scope and range of equivalents of the claims.

The construction of the invention, however, together with the additional objects and advantages thereof will be best understood from the following description of the specific embodiments when read in connection with the accompanying drawings.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is an exploded view of an instrument display in accordance with the prior art;

FIG. 2 is a cross-sectional, side view of an instrument display in accordance with the prior art;

FIG. 3 is a simplified view of a portion of an instrument display useful in explaining one particular embodiment of the present invention;

FIG. 4 is a perspective view of a light conductor or light guide in accordance with one particular embodiment of the invention; and

FIG. 5 is a partial exploded view of an instrument display including a light conductor and PCB in accordance with one particular embodiment of the present invention.

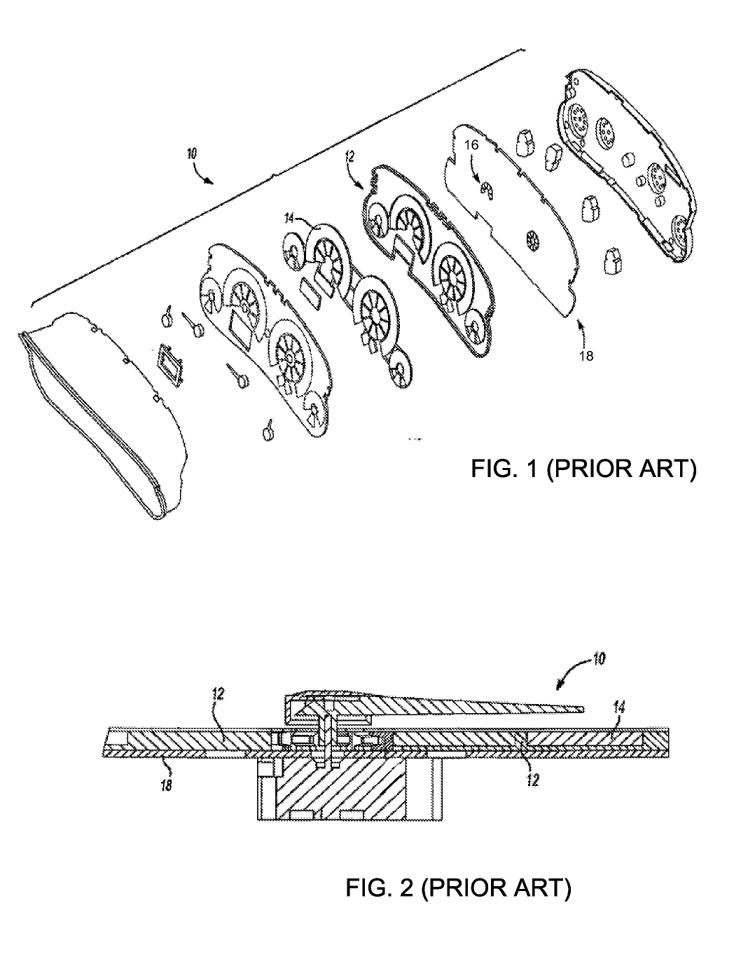

### DETAILED DESCRIPTION OF THE PREFERRED EMBODIMENTS

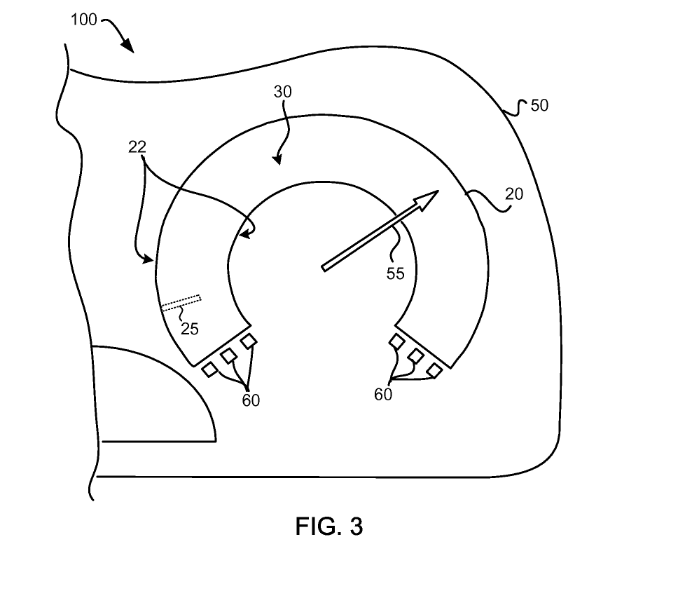

Referring now to FIGS. 3-5, there will now be described one particular embodiment of an instrument display 100 using instrument clusters in, for example, passenger or commercial vehicles. The instrument display 100 of the present embodiment includes a printed circuit board (PCB) 50 and a light guide or conductor 20. One or more light sources 60, 70 and/or 80 are arranged on the PCB 50 near the light conductor 20 so as to be used to direct light into the light conductor. As known, a pointer 55 is connected to a movement to rotate along the circular path of light conductor 20. The light sources 60, 70 and/or 80 illuminate the light conductor 20, such that the light conductor 20 can be used as a back light for dials (as shown in FIGS. 3 and 5) or other decorative illumination for the instrument display 100. The position and quantity of the light sources 60, 70 and/or 80 will depend on the application and the desired intensity. Additionally, in one particular embodiment of the invention, at least the light sources 60 are light emitting diodes (LEDs).

In the preferred embodiment of the invention, the light conductor 20 is attached directly (i.e., without a support frame or light housing) to the PCB 50. More particularly, a rear face of the light guide 20 is adhered directly to, and in full contact with, a front face of the PCB 50. In one particular embodiment of the invention, the light conductor 20 is adhered directly to the PCB 50 using an adhesive. Use of a light conductor 20 directly attached to the PCB 50 will eliminate a plastic part (frame or light housing) used in current assemblies and simplifies the design, thus creating new possibilities cosmetically, in illumination and in decorative features.

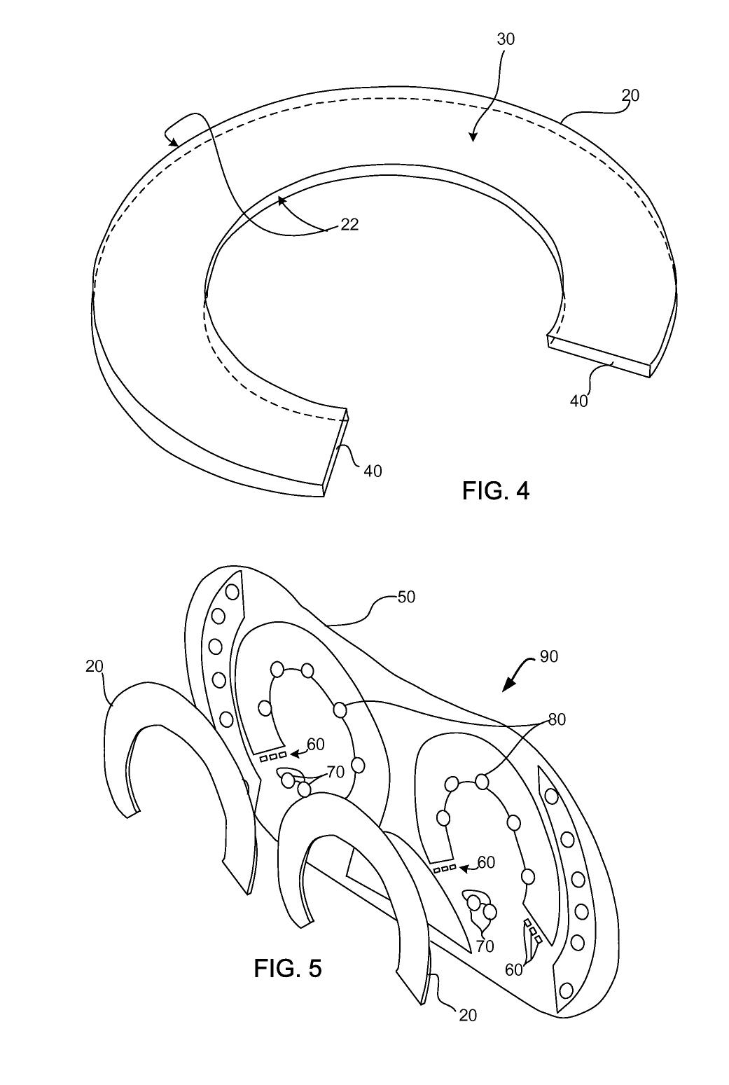

Referring more particularly to FIGS. 3 and 4, the light sources 60 on the PCB are arranged so as to direct light from the light sources 60 to light collectors or light collecting faces 40 of the light conductor 20 and travels inside the light conductors 20, reflecting light where needed, to provide a backlight or direct illumination. Alternately, a separate, translucent light collector may be provided between the light source and the light conductor 20 to direct light from the light source into the body of the light conductor 20. The body of the light conductor 20 is preferably made of a translucent or clear, light conducting material, such as silicone, glass, plastic, or other light transmitting/non-opaque clear materials, as desired. It should be noted that the light conductor 20 can be made to be flexible (i.e., non-rigid), permitting bending of the light conductor 20 and arrangement in the instrument display 120 in new ways to provide new cosmetic possibilities and illumination. However, it is intended that, in accordance with the present invention, such a light conductor 20 will be adhered directly to the underlying PCB 50, preferably with an adhesive, as described elsewhere herein.

In one particular embodiment of the invention, light from the light sources 60 enter the light collecting faces 40 of the light conductor 20 and is emitted from the emitting surface 30 of the light conductor 20, while the faces 22 of the light conductor 20 reflect light within the light conductor 20. In one particular embodiment, the faces 22 could be painted white, if desired, so as to increase the reflection of light within the light conductor 20 and emission from the emitting surface 30. Additionally, the bottom surface of the light conductor 20 (i.e., the face that is attached directly to the PCB 50, includes a white coating, in order to improve reflection from the emitting surface 30. Such a white coating can be applied to the bottom surface by painting or application of a foil or some other process, as desired. Additionally, if desired, marks or reflecting surfaces (such as indicator line 25) can be placed on or in the body of the light conductor 20. For example, the upper surface or emitting face 30 of the light conductor 20 (i.e., the face not in direct contact with the PCB 50) can be made to include reflecting surfaces, such as dots (in silicone light conductors 20) and/or microstructures (in plastic or glass light conductors 20) that can reflect the light as described more particularly in col. 5 of the '972 patent, lines 5-54, (that reference being previously incorporated herein, by reference in its entirety). Other types of structures can be used as well in plastic and/or glass, such as eroded structures (i.e., formed by VDI and/or Charmilles Technologies™ erosion processes).

The present invention simplifies the manufacture and design of instrument clusters by adhering the light conductor 20 directly to the PCB 50 near the light sources 60 without an extra piece, light housing or frame structure being required. This results in thinner instrument clusters having less weight and costing less to produce.

Although the invention is illustrated and described herein as embodied in an instrument cluster including a PCB mounted light conductor, it is nevertheless not intended to be limited to only these details shown. As can be seen, various modifications and structural changes may be made therein without departing from the spirit of the invention and within the scope and range of equivalents of the claims.

What is claimed is:

1. An instrument display for a vehicle, comprising:
a printed circuit board including at least one light source disposed on a first surface of the printed circuit board;
a light conductor affixed directly to said first surface of the printed circuit board such that light from said at least one light source is provided inside a body of said light conductor;
said light conductor including a light emitting face disposed opposite to a face of said light conductor adhered to said first surface.

2. The instrument display of claim 1, wherein a first surface of said light conductor is directly adhered to said first surface of the printed circuit board using an adhesive.

3. The instrument display of claim 2, wherein said light conductor is translucent.

4. The instrument display of claim 1, wherein the light conductor includes at least one reflecting face at an edge of said body.

5. The instrument display of claim 4, wherein said at least one reflecting face is painted to reflect light inside said body.

6. The instrument display of claim 5, wherein said at least on reflecting face is painted white.

7. The instrument display of claim 1, wherein said light conductor is translucent.

8. The instrument display of claim 7, wherein said light conductor is flexible.

9. The instrument display of claim 7, wherein said light conductor is fabricated from silicone.

10. The instrument display of claim 8, wherein said light conductor includes at least one reflecting surface on or in the body of the light conductor.

11. A method of making an instrument cluster, comprising the steps of:
providing a printed circuit board including at least one light source disposed on a first surface of the printed circuit board;
affixing a translucent light conductor directly to a first surface of the printed circuit board such that light from the at least one light source is provided into a body of the light conductor, the light conductor including a light emitting face disposed opposite to a face of the light conductor adhered to the first surface.

12. The method of claim 11, wherein a first surface of said light conductor is directly adhered to said first surface of the printed circuit board using an adhesive.

13. The method of claim 11, wherein the light conductor includes at least one reflecting face at an edge of the body.

14. The method of claim 13, wherein the at least one reflecting face is painted to reflect light inside the body.

15. The method of claim 14, wherein the at least on reflecting face is painted white.

16. The method of claim 11, wherein the light conductor is translucent.

17. The method of claim 16, wherein the light conductor is flexible.

18. The method of claim 17, wherein the light conductor is fabricated from silicone.

19. The method of claim 18, wherein the light conductor includes a reflecting surface on or in the body of the light conductor.

20. An instrument cluster, comprising:
a printed circuit board including at least one light source disposed on a first surface of the printed circuit board;
a translucent light conductor affixed directly to said first surface of the printed circuit board such that light from said at least one light source is provided inside a body of said light conductor;
said light conductor including a light emitting face disposed opposite to a face of said light conductor adhered to said first surface.
